(19) United States
(12) Patent Application Publication
(10) Pub. No.: US 2004/0218153 A1
(43) Pub. Date: Nov. 4, 2004

(54) METHOD AND APPARATUS OF ASSEMBLING OPTICAL ENGINE

(76) Inventor: Kuo-Wen CHEN, Miao-Li County (TW)

Correspondence Address: NAIPO (NORTH AMERICA INTERNATIONAL PATENT OFFICE), P.O. BOX 506, MERRIFIELD, VA, 22116, US

(21) Appl. No.: 10/709,103

(22) Filed: Apr. 14, 2004

(30) Foreign Application Priority Data
Apr. 29, 2003 (TW) 092110249

(51) Int. Cl. G03B 21/28

(52) U.S. Cl. 353/78

(57) ABSTRACT

A method and apparatus of assembling an optical engine is disclosed. The method includes the steps of locating an optical engine onto a carrier; placing the optical engine and the carrier into a casing; providing a position adjusting device that is located out of the casing device to connect to the carrier; adjusting the position of the optical engine by the adjusting device; fixing the carrier in place via an adhesive; removing the position adjusting device from the casing. Thereby, the assembling of the optical engine is achieved. Since the position adjustment of the optical engine is achieved by the position adjusting device that is located outside the module, each module is not necessarily provided with one position adjusting device. Therefore, the position adjustment is efficiently and economically performed without any space limit.

### BACKGROUND OF INVENTION

1. Field of the Invention

The present invention relates to a rear projecting television, and more particularly to a process of assembling an optical engine in a rear projecting television.

2. Description of the Prior Art

Referring to FIG. 1, a conventional rear projecting television includes an optical engine 1, a plurality of reflecting mirrors 2A, 2B and a screen 3. The optical engine 1 generates image beams that are then reflected by the reflecting mirrors 2A, 2B to change light paths and reduce the volume of the beams. The beams are reflected several times to exactly focus in a projecting direction to form an image onto the screen.

However, the assembly and production tolerance of the optical engine 1 adversely affect the image shaping and the beam focusing in the projecting direction. When an optical engine is to be assembled, the optical engine 1 is mounted on an adjusting device 4 and then put into a casing 5. Referring to FIG. 2, the adjusting device 4 includes an elevating base 40A, three rotatory bases 40B, 40C, 40D and two slidable bases 40E, 40F stacked from top to bottom. The elevating base 40A allows the axial adjustment of the optical engine in Y axis. The rotaory bases 40B, 40C and 40D respectively allow the axial adjustment of the optical engine in X axis, Y axis and Z axis. The slidable bases 40E and 40F respectively allow the axial adjustment of the optical engine in X axis and Z axis. Each base is provided with corresponding devices to for adjusting the position and angle of the optical engine. After the optical engine has been adjusted, it is fixed via screws to finish the assembling of the optical engine.

Since the adjustment of the optical engine is performed inside the casing, the assembling space is limited to the casing and thus the assembling time is increased. Each optical engine is provided with one adjusting device as described above that occupies certain space in the casing, which increases the whole product cost and dimension.

### SUMMARY OF INVENTION

It is one object of the invention to provide a process of assembling an optical engine. An optical engine is mounted on a carrier. The carrier and the optical engine thereon are placed in a casing. A position adjusting device is provided outside the casing to connect to the carrier. The position of the optical engine is adjusted via adjusting the position of the carrier by the position adjusting device. Thereby, the assembly time and cost are reduced.

It is another object of the invention to provide a process of assembling an optical engine, in which a position adjusting device connects to a carrier and adjusts the position of the optical engine via the carrier without any space limit of the optical engine.

In order to achieve the above and other objectives, the process of assembling an optical engine according to the invention includes mounting an optical engines on a carrier; placing the optical engine and the carrier in a casing; providing a position adjusting device outside the casing to connect to the carrier; adjusting the position of the optical engine by the position adjusting device; fixing the optical engine via an adhesive; after the adhesive is hardened, removing the position adjusting device to complete the assembling of the optical engine. Since the position adjustment of the optical engine is achieved by the position adjusting device that is located outside the module, the assembling of individual optical engine only needs one position adjusting device, and the position adjustment is efficiently and economically performed without any space limit.

It will be understood that the foregoing summary encompasses some of the many features of the invention, and does not constitute an exhaustive description of all the aspects of the invention. Therefore, the summary of the invention should not be construed in a way to limit the scope of the invention as descried in the claims. To provide a further understanding of the invention, the following detailed description illustrates embodiments and examples of the invention.

### BRIEF DESCRIPTION OF DRAWINGS

FIG. 1 is a side view of a conventional rear projection television;

FIG. 2 is a schematic view of a conventional position adjusting device used for adjusting an optical engine;

FIG. 3A, FIG. 3B, FIG. 3C and FIG. 3D are schematic views illustrating a process of assembling an optical engine according to one embodiment of the invention;

FIG. 4 is a flowchart of a process of assembling an optical engine according to one embodiment of the invention; and

FIG. 5 is a perspective view of a position adjusting device and a carrier used in assembling an optical engine according to one embodiment of the invention.

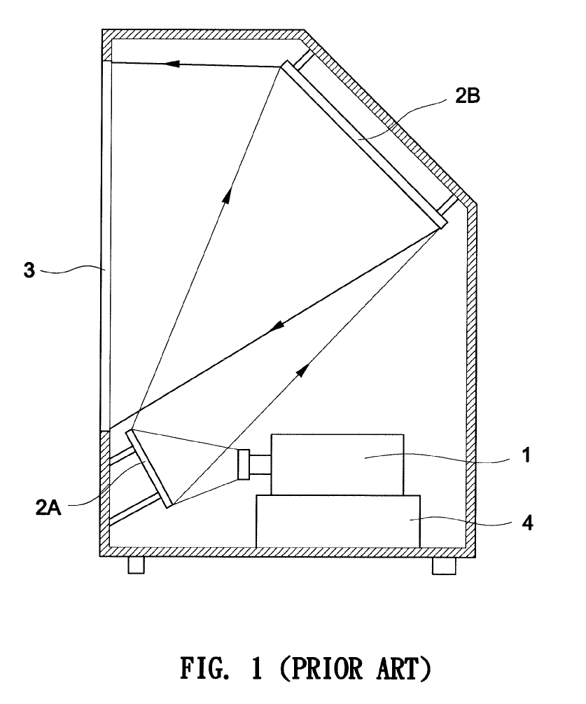

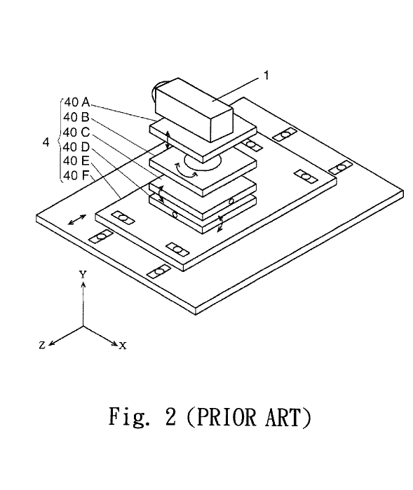

### DETAILED DESCRIPTION

The following description of the present invention is intended to be illustrative only and not limiting.

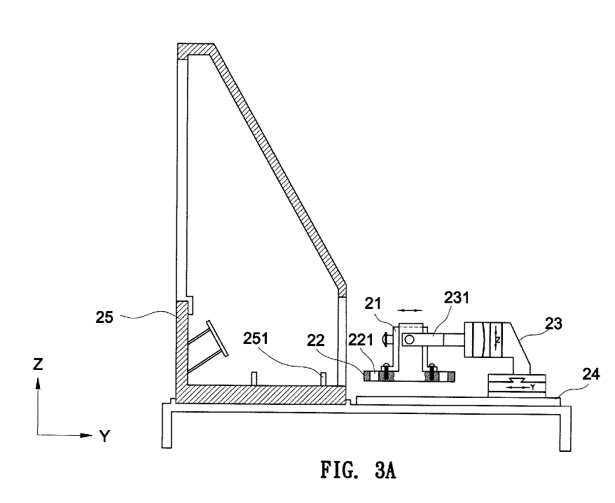

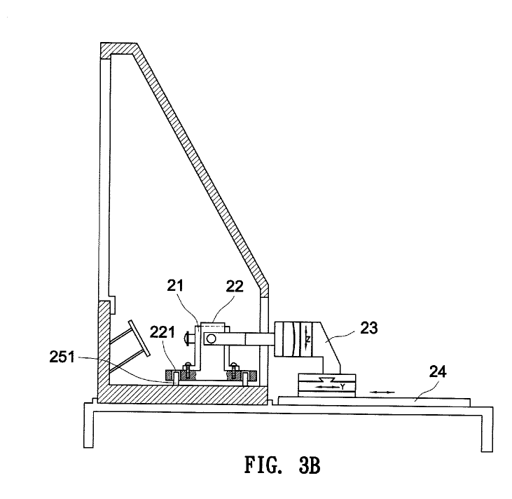

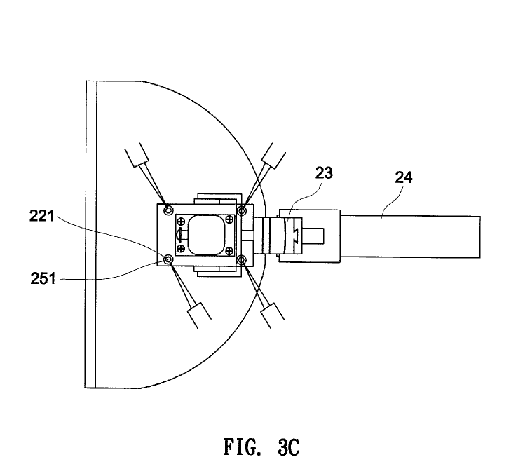

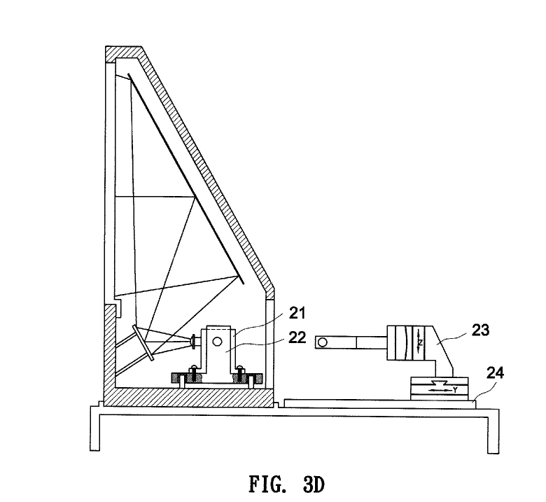

Referring to FIG. 3A, an optical engine 21 is mounted on a carrier 22. A position adjusting device 23 having a clapping portion at its front end is placed on a slide rail 24. The clapping portion 231 can be further provided with a switch to control the opening and closing operation of the clapping portion 231. When the clapping portion 231 closes, the carrier 22 is held by the clapping portion 231. FIG. 3B, the position adjusting device 23 slides along the slide rail 24 in Y-axis direction until the clapping portion 231 puts the carrier 22 into a casing 25. The carrier 22 and the casing 25 have corresponding through holes and studs 251. When the carrier 22 is placed inside the casing 25, the studs 251 insert into the through holes 221 to secure the carrier 22 to the casing 25 with a gap between one through hole 221 and one stud 251 for adjustment. Then, the position adjusting device 23 adjusts the position and angle of the carrier 22 until the optical engine 21 aligns with a projecting direction. The position adjusting device 23 can be a multi-axis fixture. Referring to FIG. 3C, an adhesive is charged into the gaps between through holes 221 and the studs 251, and then cured by irradiating UV light. The cured adhesive tightly bonds the carrier 22 to the casing 25. Referring to FIG. 3D, the clapping portion 231 opens to release the carrier 22. Then the position adjusting device 23 moves along the slide rail 24 in a reverse direction until the clapping portion 231 arrives outside the casing 25. Thereby, the assembling of the optical engine is achieved.

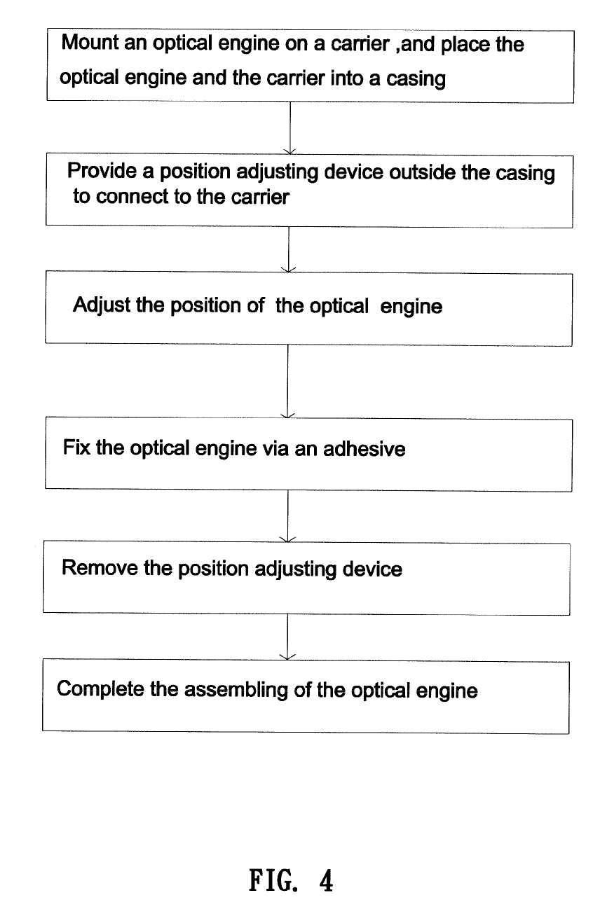

Referring to FIG. 4, the process of the invention includes mounting an optical engine 21 on a carrier 22, and then placing the optical engine 21 and the carrier 22 into a casing 25. A position adjusting device 23 is provided outside the casing 25 to adjust the optical engine 21 in situ. After the optical engine 21 has been positioned, the carrier 22 is fixed via adhesive. Then, the position adjusting device 23 is removed and thereby the optical engine 22 is assembled in the casing 25.

When the optical engine 21 is to be adjusted, a clapping portion 231 of the position adjusting device 23 inserts in the casing to hold the carrier 22, while the remaining part of the position adjusting device stays outside the casing 25. The user operates the remaining part of the position adjusting device 23 to adjust the position of the optical engine in the casing 25. After the optical engine 21 is adjusted, the position adjusting device 23 and its clapping portion 231 are removed. Therefore, adjusting the optical engine 21 can be efficiently and economically performed without space limit. Compared to the conventional process of assembling the optical engine, there is no need to provide each optical engine module with one position adjusting device, thereby simplifying the configuration of the optical engine and saving the assembling cost. Since no position adjusting device is fixedly mounted inside the casing, the size of the optical engine module is reduced.

With the clapping portion of the position adjusting device 23 holding the carrier 22, the adjustment of the optical engine is achieved via the adjustment of the carrier 22 on which the optical engine 21 is located. Therefore, a plurality of optical engines 21 can be separately assembled with the use of one position adjusting device 23. The process of the invention can be applied in assembling optical engines of different structural design.

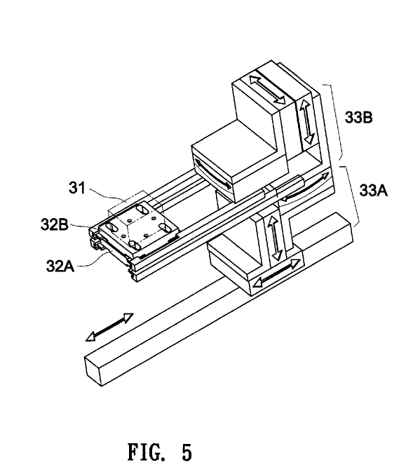

Referring to FIG. 5, when the optical engine 31 needs axial adjustment, a plurality of carriers 32A and 32B stack one another in a manner that one carrier 32A corresponds to one position adjusting device 33A and one carrier 32B corresponds to one position adjusting device 33B so that the adjustment job can be properly allocated over these position adjusting devices to further reduce the assembling time.

Those skilled in the art will readily understand that the above description is only illustrative of specific embodiments and examples of the invention, which should not be construed in a limiting way. Therefore, the invention should cover various modifications and variations made to the structure and operations described herein, provided they fall within the scope of the invention as defined in the following appended claims.

What is claimed is:

1. A process of assembling an optical engine, comprising:
(A) mounting one optical engine on a carrier, and then placing the optical engine and the carrier into a casing;
(B) providing a position adjusting device outside the casing to connect to the carrier;
(C) adjusting the position of the optical engine in situ via the position adjusting device;
(D) fixing the carrier via an adhesive; and
(E) removing the position adjusting device from the casing.

2. The process of claim 1, wherein the position adjusting device has at least one clapping portion at its front end to hold the carrier.

3. The process of claim 1, wherein the carrier has at least one through hole and the casing has at least one stud therein to correspond to the through hole so that when the carrier is placed in the casing, the through hole and the stud are matching to each other.

4. The process of claim 3, wherein the step of fixing the carrier includes charging the adhesive between the through hole and the stud; and irradiating UV light to cure the adhesive.

5. The process of claim 2, wherein the carrier includes a plurality of carriers stacked one another, each carrier having one clapping portion to clap the carrier.

6. An optical engine module, comprising:
a casing, having at least one stud therein;
at least one carrier, used to support the optical engine and having at least one through hole corresponding to the stud;
one adjusting device, located outside the casing to adjust the position of the optical engine, and having at least one clapping portion at its front end; and
an adhesive, used to fix the carrier inside the casing.
